(19) United States
(12) Patent Application Publication
(10) Pub. No.: US 2003/0231657 A1
(43) Pub. Date: Dec. 18, 2003

(54) System and method for a multi-data network layer transmit interface

(76) Inventors: Kacheong Poon, Milpitas, CA (US); Cahya Adi Masputra, Millbrae, CA (US)

Correspondence Address: WAGNER, MURABITO & HAO LLP, Third Floor, Two North Market Street, San Jose, CA, 95113, US

(21) Appl. No.: 10/170,919

(22) Filed: Jun. 12, 2002

(51) Int. Cl. H04J 3/16

(52) U.S. Cl. 370/469; 370/395.5

(57) ABSTRACT

A kernel data transfer method and system for transmitting multiple packets of data in a single block of data presented by application programs to the kernel's network subsystem for processing in accordance with data transfer parameters set by the application program. The multi-data transmit system includes logic that allows header information of the multiple packets of data to be generated in a single buffer and appended to a second buffer containing the data packets to be transmitted through the network stack. The multi-data transmit system allows a device driver to amortize the input/output memory management related overhead across a number of packets. With some assistance from the network stack, the device driver needs to only perform the necessary IOMMU operations on two contiguous memory blocks representing the header information and the data payload of multiple packets during each transmit call.

### CROSS REFERENCE TO RELATED APPLICATION

This is related to Masputra et al., co-filed U.S. patent application Ser. No. ______: attorney docket No.: SUN-P7825, entitled “A SYSTEM AND METHOD FOR AN EFFICIENT TRANSPORT LAYER TRANSMIT INTERFACE”. To the extent not repeated herein, the contents of Masputra et al., are incorporated herein by reference.

### FIELD OF THE INVENTION

The present claimed invention relates generally to the field of computer operating systems. More particularly, embodiments of the present claimed invention relate to a system and method for a multi-data network layer transmit interface.

### BACKGROUND ART

A computer system can be generally divided into four components: the hardware, the operating system, the application programs and the users. The hardware (e.g., central processing unit (CPU), memory and input/output (I/O) devices) provides the basic computing resources. The application programs (e.g., database systems, games, business programs, etc.) define the ways in which these resources are used to solve the computing problems of the users. The operating system controls and coordinates the use of the hardware among the various application programs for the various users. In so doing, one goal of the operating system is to make the computer system convenient to use. A secondary goal is to efficiently make use of the hardware.

The Unix operating system (Unix) is one example of an operating system that is currently used by many enterprise computer systems. Unix was designed to be a simple time-sharing system, with a hierarchical file system, which supports multiple processes. A process is the execution of a program and consists of a pattern of bytes that the CPU interprets as machine instructions or data.

Unix consists of two separable parts which include the “kernel” and “system programs.” Systems programs typically consist of system libraries, compilers, interpreters, shells and other such programs which provide useful functions to the user. The kernel is the central controlling program that provides basic system facilities. For example, the Unix kernel creates and manages processes, provides functions to access file-systems, and supplies communications facilities.

The Unix kernel is the only part of the Unix operating system that a user cannot replace. The kernel also provides the file system, CPU scheduling, memory management and other operating-system functions by responding to “system-calls.” Conceptually, the kernel is situated between the hardware and the users. System calls are the means for the programmer to communicate with the kernel.

System calls are made by a “trap” to a specific location in the computer hardware (sometimes called an “interrupt” location or vector). Specific parameters are passed to the kernel on the stack and the kernel returns with a code in specific registers indicating whether the action required by the system call was completed successfully or noL.

FIG. 1 is a block diagram illustration of a prior art computer system 100. The computer system 100 is connected to an external storage device 180 and to an network interface device 120 through which computer programs can be loaded into computer system 100. External storage device 180 and network interface device 120 are connected to the computer system 100 through respective bus lines. Computer system 100 further includes main memory 130 and processor 110. Device 120 can be a computer program product reader such a floppy disk drive, an optical scanner, a CD-ROM device, etc.

FIG. 1 additionally shows memory 130 including a kernel level memory 140. Memory 130 can be virtual memory which is mapped onto physical memory including RAM or a hard drive, for example. During process execution, a programmer programs data structures in the memory at the kernel level memory 140.

The kernel in FIG. 1 comprises a network subsystem. The network subsystem provides a framework within which many network architectures may co-exist. A network architecture comprises a set of network-communication protocols, the protocol from naming conventions for naming communication end-points, etc.

The kernel network subsystem 140 comprises three logical layers as illustrated in FIG. 2. These three layers manage the following tasks in the kernel; inter-process data transport; internetworking addressing; and message routing and transmission media support. The prior art kernel network subsystem 200 shown in FIG. 2 comprises a transport layer 220, a networking layer 230, and a link layer 240. The transport layer 220 is the topmost layer in the network subsystem 200.

The transport layer 220 provides an addressing structure that permits communication between network sockets and any protocol mechanism necessary for socket sematics, such as reliable data delivery. The second layer is the network layer 230. The network layer 230 is responsible for the delivery of data destined for remote transport or network layer protocols. In providing inter-network delivery, the network layer 230 manages a private routing database or utilizes system-wide facilities for routing messages to their destination host.

The lowest layer in the network subsystem is the network interface layer 240. The link layer 240 is responsible for transporting messages between hosts connected to a common transmission medium. The link layer 240 is mainly concerned with driving the transmission media involved and performing any necessary link-level protocol encapsulation and de-encapsulation.

FIG. 3 is a block diagram of a prior art internet protocol (IP) for the network subsystem 200. The Internet protocol in FIG. 3 provides a framework in which host machines connecting to the kernel 140 are connected to the network with varying characteristics and the network interconnected with gateways. The Internet protocol illustrated in FIG. 3 is designed for packet switching networks which provide reliable message delivery and notification of failure to pure datagram networks, such as the Ethernet that provides no indication of datagram delivery.

The IP layer 300 is the level responsible for host to host addressing and routing packet forwarding and packet fragmentation and re-assemble. Unlike the transport protocols, it does not always operate on behalf of a socket or the local links. It may forward packets, receive packets for which there are no local socket, or generate error packets in response. The function performed by the IP layer 300 are contained in the packet header. The packet header identifies source and destination hosts and the destination protocol.

The IP layer 300 processes data packets in one of four ways: 1) the packet is passed as input to a higher-level protocol; 2) the packet encounters an error which is reported back to the source; 3) the packet is dropped because of an error or the packet is forwarded along a path to its destination.

The IP layer 300 further processes any IP options in the header, checks packets by verifying that the packet is at least as long as an IP header, checksums the header and discards the packet if there is an error, verifies that the packet is at least as long as the header and checks whether the packet is for the targeted host. If the packet is fragmented, the IP layer 300 keeps it until all its fragments are received and reassembled or until it is too old to keep.

The major protocol of the Internet protocol suite is the TCP layer 310. The TCP layer 310 is a reliable-connection oriented stream transport protocol on which most application protocols are based. It includes several features not found in the other transport and network protocols for explicit and acknowledged connection initiation and termination and includes reliable, inorder unduplicated delivery of data, flow control and out-of band indication of urgent data.

The data may typically be sent in packets of small sizes and at varying intervals; for example, when they are used to support a login session over the network. The stream initiation and termination are explicit events after the start and end of the stream, and they occupy positions in a separate space of the stream so that they can be acknowledged in the same manner as the data.

A TCP packet contains an acknowledgement and a window field as well as data, and a single packet may be sent if any of these three changes. A naive TCP send might send more packets than necessary. For example, consider what happens when a user types one character to a remote-terminal connection that uses remote echo. The server side TCP receives a single-character packet. It might send an immediate acknowledgement of the character. Then milliseconds later, the login server would read the character, removing it from the receive buffer. The TCP might immediately send a window update notice that one additional octet of send window is available. After another millisecond or so, the login server would send an echo character of input.

All three responses (the acknowledgement, the window updates and the data returns) could be sent in a single packet. However, if the server were not echoing input data, the acknowledgement cannot be withheld for too long a time, or the client-side TCP would begin to retransmit.

In the network subsystem illustrated in FIGS. 1-3, the underlying operating system has limited capabilities for handling bulk-data transfer. For many years, there has been an attempt in formulating the network throughput to directly correlate to the underlying host CPU speed, i.e., 1 megabit (Mbps) network throughput per 1 megahertz (MHz) of CPU speed. Although such paradigms may have been sufficient in the past for low bandwidth network environment, they may not be adequate for today's high-speed networking mediums, where bandwidths specified in units of gigabit per second (Gbps) are becoming increasingly common and create a tremendous overhead processing cost for the underlying network software.

Networking software overhead can be classified into per-byte and per-packet costs. Prior analysis of per-byte data movement cost in prior art operating system networking stacks show that data copy function and checksum overhead function dominate host CPU processing time. Other analysis of the per-packet cost has revealed that the overhead associated with some prior art operating systems is as significant as the per-byte costs.

In analyzing the prior overhead costs of processing and transmitting data in the kernel's network subsystem, FIG. 4 is a prior art illustration of a kernel network subsystem 400 having a data STREAM head module 420 for generating network data for transmission in the network subsystem 400. The stream head module 420 is the end of the stream nearest the user process. All system calls made by user-level applications on a stream are processed by the stream head module. The stream head 420 typically copies the application data from user buffers into kernel buffers, and during the copying process, it may provide the data into small chunks, based on the header and data payload. The stream head module 420 may also reserve some extra space in front of each allocated kernel buffer depending on the static packet value.

Currently, the TCP module 430 utilizes these parameters in an attempt to optimize the transmit dynamics and reducing allocation cost for the TCP/IP and link-layer headers in the kernel. By setting the data packet to a size large enough to hold the headers while setting the data to a maximum TCP segment size, the TCP module 430 effectively instructs the stream head module 420 to divide the application data into two kernel buffers for every system call to the TCP module 430 to transmit a single data packet.

For applications which transmit bulk data, it is not uncommon to see buffer sizes in the range of 32 KB, 64 KB, or larger. Applications typically inform the TCP module 430 /IP module 440 of this size in order for the modules to configure and possibly optimize the transmit characteristics, by configuring the send buffer size. Ironically for the TCP module 430, this strategy has no effect in optimizing the stream head module 420 behavior, due to the fact that the user buffer is broken up into maximum segment size (MSS) chunks that the TCP module 430 can handle.

For example, a 1 MB user buffer written to the socket causes over 700 kernel buffer allocations in the typical 1460-bytes MSS case, regardless of the size. This method is quite inefficient, not only because of the costs incurred per allocation, but also because the application data written to the socket cannot be kept in larger contiguous chunks.

In the prior art systems shown in FIGS. 1-4, a socket's STREAMS processing consist of the stream head 420, the transport module 430, the network module 440 and the driver 450. Application data residing in the kernel buffers are sent down through each module's queue via a STREAMS framework. The framework determines the destination queue for the message, hence providing a sense of abstraction between the modules.

In the system shown in FIG. 4, packet chaining with STREAMS is one in which multiple packets (each represented by a mblk) are chained altogether using the existing b_prev and b_next fields defined in the memory block (mblk) structure. This prior art system, however, has some limitations.

One prior art solution to the large processing overhead cost of handling bulk data transmission is the implementation of a hardware large send offload feature. The large send offload is a hardware feature implemented by prior art Ethernet cards that virtualize the link maximum transmission unit, typically up to 64 KB) from the network stack. This enables the TCP/IP modules to reduce per-packet costs by the increased virtual packet size. Upon receiving the jumbo packet from the networking stack, the NIC driver instructs the on-board firmware to divide the TCP payload into smaller segments (packets) whose sizes are based on the real TCP MSS (typically 1460 bytes). Each of this segments of data is then transmitted along with the TCP/IP header created by the firmware, based on the TCP/IP header of the jumbo packet as shown in FIG. 5.

Although this prior art solution dramatically reduces the per-packet transmission costs, it does not provide a practical solution because this solution is exclusively tailored for TCP and depends on the firmware's ability to correctly parse and generate the TCP/IP headers (including IP and TCP options). Additionally, due to the virtual size of the packets, many protocols and/or technologies which operate on the real headers and payload, e.g., IPsec will cease to function. It also breaks the TCP processes by luring the TCP module 430 into using larger maximum transmission unit (MTU) compared to the actual link MTU. Since the connection endpoints have different notion of the TCP MSS, it inadvertently brings harm to the congestion control processes used by TCP. Doing so would introduce unwanted behavior, such as high rate of retransmissions caused by packet drops.

The packet chaining data transmission of the prior art system therefore requires data to be transmitted in the network subsystem in small packets. Also required are the creation of individual headers to go with each packet that requires the sub-layers of the network subsystem to transmit pieces of the same data, due to the fixed packet sizes, from a source to a destination host. Such transmission of data packets is not only time consuming and cumbersome, but very costly and inefficient. Supporting protocols other than TCP over plain IP would require changes made to the firmware which in itself is already complicated and poses a challenge for rapid software development/test cycles. Furthermore, full conformance to the TCP protocol demands that some fundamental changes to operating system networking stack implementation, where a concept of virtual and real link MTU is needed.

### SUMMARY OF INVENTION

Accordingly, to take advantage of the many application programs available and the increasing number of new applications being developed and the requirement of these new applications for fast network bandwidth, a system is needed that optimizes data transmission through a kernel network subsystem. Further, a need exists for solutions to allow for the multi-packet transfer of data in a computer system without incurring the costly delay of transmitting each piece of data with an associated header information appended to the data before transmitting the data. A need further exists for an improved and less costly method of transmitting data without the inherent prior art problem of streaming individual data packet headers with each data transmitted in the network subsystem.

What is described herein is a computer system having a kernel network subsystem that provides a system and a technique for providing a multi-packet data transfer from applications to the network subsystem of the kernel without breaking down the data into small data packets. Embodiments of the present invention allow programmers to optimize data flow through the kernel's network subsystem on the main data path connection between the transport connection protocol and the Internet protocol suites of the kernel.

Embodiments of the present invention allow multi-packet data sizes to be dynamically set in order to avoid a breakdown of application data into small sizes prior to being transmitted through the network subsystem. In one embodiment of the present invention, the computer system includes a kernel transport layer transmit interface system that includes optimization logic for enabling code that enables kernel modules to transmit multiple data packets in a single block of application data using a bulk transfer of such data without repetitive send and resend operations.

The multi-data transmit interface logic further provides a programmer with a number of semantics that may be applied to the extension data along with the manipulation interfaces that interact with the data. The transport layer transmit interface logic system of the present invention further allows the data packetizing to be implemented dynamically according to the data transfer parameters of the underlying kernel application program.

Embodiments of the present invention further include data flow optimizer logic to provide a dynamic sub-division of application data based on a specific parameter presented by the application data to the kernel's network subsystem. The data flow optimizer optimizes the main data path of application program datagrams through the Internet protocol module of the network sub-system and the transport control protocol module.

Embodiments of the present invention also include a data copy optimization module that provides a mechanism for enabling the multi-data transmission logic of the present invention to implement a multi-packet copy of data from a data generation module to the lower modules in the network subsystem. The present invention provides a mechanism for performing basic configuration for stream datagrams from the application programs in the host system to the network susbsystem.

Embodiments of the present invention further include a header data generation buffer sizer. The header data buffer sizer dynamically determines the number of segments of data in each data block to transmitted and generates a single header buffer to store all the header information corresponding to the data segments. The data buffer sizer dynamically adjusts the size of datagram copied from the data generation module to the IP and TCP module in the kernel.

Embodiments of the present invention further include a segment data generation buffer. The segment data buffer stores the data of all the segments making up the data block to be transmitted in the kernel. Buffering the segment data in a single buffer allows the present invention to transmit multiple packets of data representing a single block of data in a single transmit cycle.

Embodiments of the present invention further include data linking logic for linking the header and segment data buffers together to define the single data block to be transmitted each transmission cycle.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram of a prior art computer system;

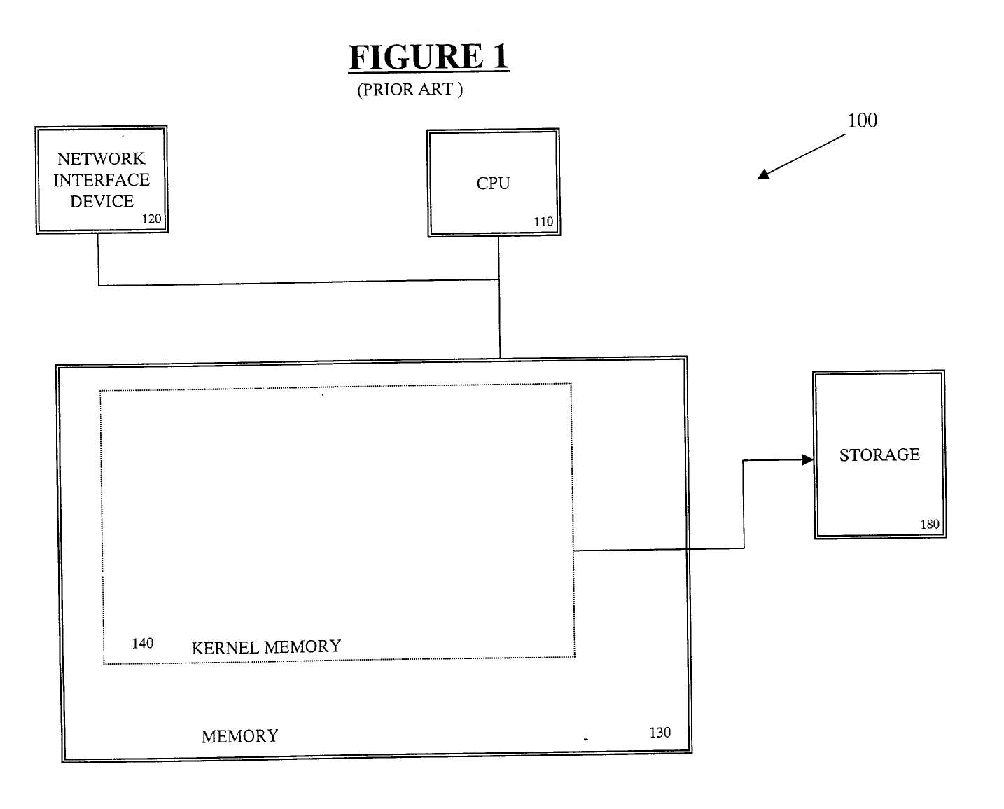

FIG. 2 is a block diagram of software layers of a prior art kernel subsystem;

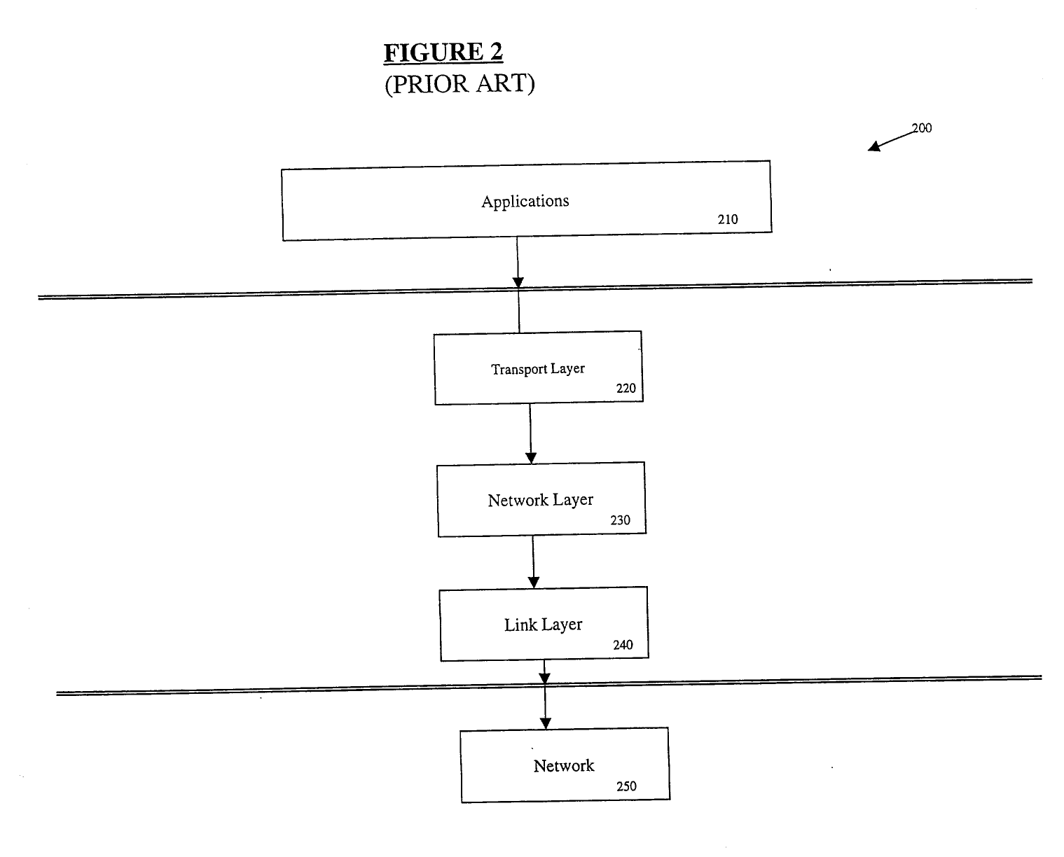

FIG. 3 is a block diagram of software layers of a network subsystem of a prior art kernel;

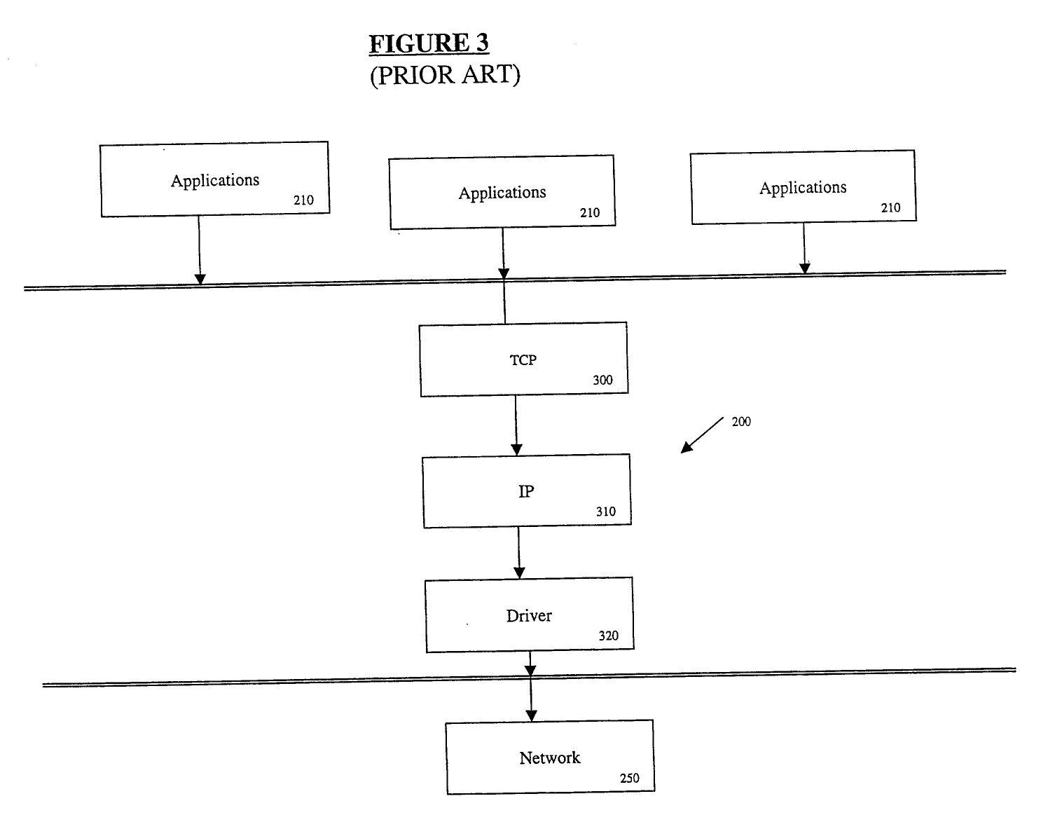

FIG. 4 is a block diagram of software layers of a prior art network module of a prior art kernel;

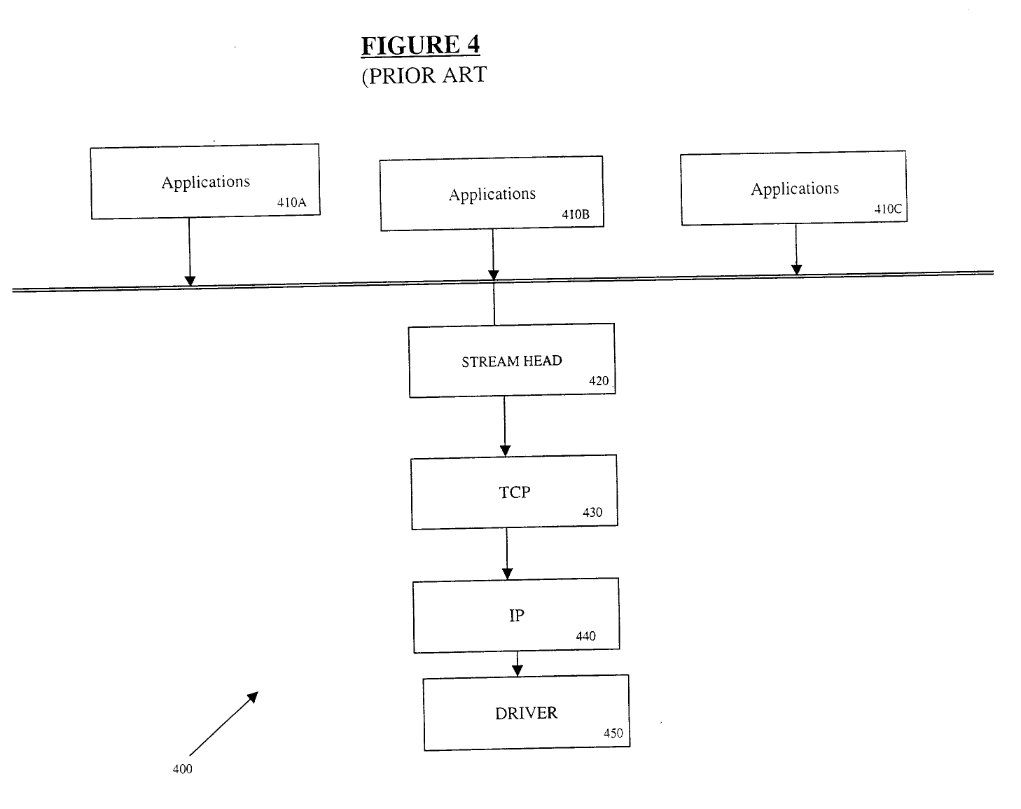

FIG. 5 is a block diagram of a prior art packet handling between the TCP and IP modules of FIG. 4;

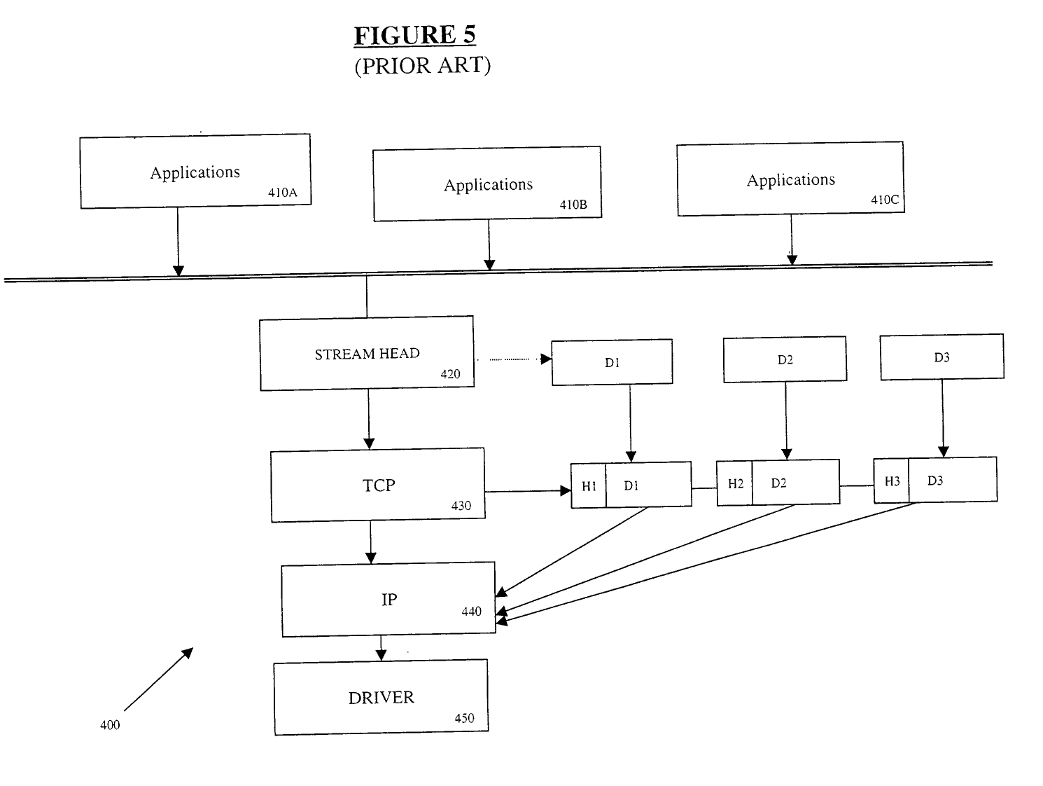

FIG. 6 is a block diagram of a computer system of one embodiment of the present invention;

FIG. 7 is a block diagram of an exemplary network subsystem with an embodiment of the multi-data transmitter of the kernel subsystem in accordance an embodiment of the present invention;

FIG. 8 is a block diagram packet organization of one embodiment of the TCP module of the present invention;

FIG. 9 is a block diagram of one embodiment of an internal architecture of one embodiment of the multi-data transmitter of the present invention; and

FIG. 10 is a flow diagram of a method of streaming data through the network layer of the kernel subsystem of one embodiment of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

The embodiments of the invention are directed to a system, an architecture, subsystem and method to process data packets in a computer system that may be applicable to an operating system kernel. In accordance with an aspect of the invention, a multi-packet data transmission optimization system provides a programmer the ability to dynamically transmit multiple packets of application program data in a single bulk transmission in the transport layer of the kernel from a computer application program over a computer network to a host device.

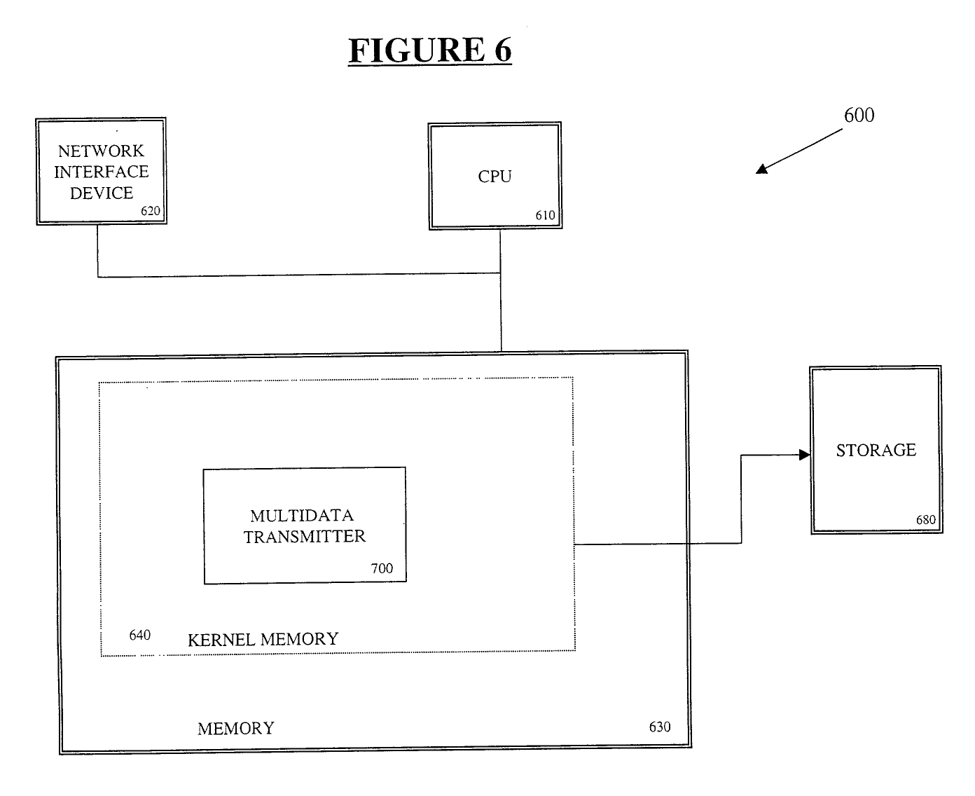

FIG. 6 is a block diagram illustration of one embodiment of a computer system 600 of the present invention. The computer system 600 according to the present invention is connected to an external storage device 680 and to an network interface drive device 620 through which computer programs according to the present invention can be loaded into computer system 600. External storage device 680 and drive device 620 are connected to the computer system 600 through respective bus lines. Computer system 600 further includes main memory 630 and processor 610. Drive 620 can be a computer program product reader such a floppy disk drive, an optical scanner, a CD-ROM device, etc.

FIG. 6 additionally shows memory 630 including a kernel level memory 640. Memory 630 can be virtual memory which is mapped onto physical memory including RAM or a hard drive, for example, without limitation. During process execution, data structures may be programmed in the memory at the kernel level memory 640. According to the present invention, the kernel memory level includes a multi-data transmission module (MDT) 700. The MDT 700 enables a programmer to optimize data packet flow through the transport layer of the network subsystem of the kernel 640.

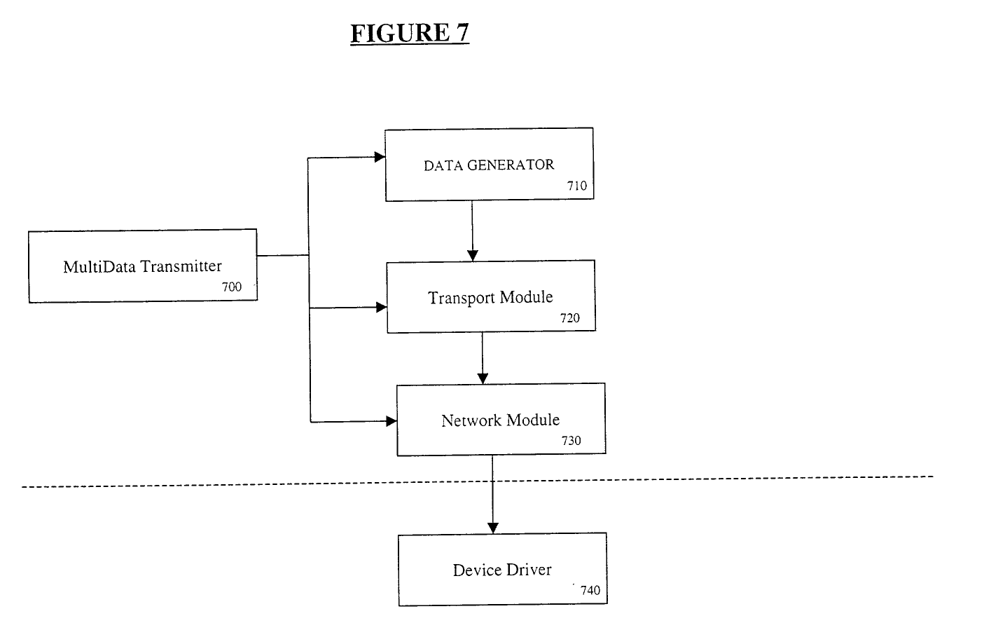

FIG. 7 is an exemplary block diagram illustration of one embodiment of the network subsystem with the MDT 700 of the kernel memory space of the present invention. The exemplary kernel memory space comprises MDT 700, kernel data generation module 710, transport module 720, network module 730 and device driver 740. The data generation module 710 provides the STREAM configuration for the present invention. The data generation module 710 generates multiple segments of data representing a single block of application data in response to multi-data transmit requests from the transport module.

The transport module 720 optimizes the performance of the main data path for an established connection for a particular application program. This optimization is achieved in part by the network module 730 knowledge of the transport module 720, which permits the network module 730 to deliver inbound data blocks to the correct transport instance and to compute checksums on behalf of the transport module 720. Additionally, the transport module 720 includes logic that enables it to substantially reduce the number of acknowledgment overheads in each data block processed in the network sub-system. In one embodiment of the present invention, the transport module 720 creates a single consolidated transport and network headers for multiple outgoing packets before sending the packets to the network module 730.

The network module 730 is designed around its job as a packet forwarder. The main data path through the network module 730 has also been highly optimized for both inbound and outbound data blocks to acknowledge and fully resolved addresses to ports the transport layer protocols have registered with the network module 730.

The network module 730 computes all checksums for inbound data blocks transmitted through the network sub-system. This includes not only the network header checksum, but also, in the transport cases. In one embodiment of the present invention, the network module 730 knows enough about the transport module 720 headers to access the checksum fields in their headers. The transport module 720 initializes headers in such a way that the network module 730 can efficiently compute the checksums on their behalf.

The multi-data transmitter 700 provides an extensible, packet-oriented and protocol-independent mechanism for reducing the per-packet transmission over-head associated with the transmission of large chunks of data in the kernel's network subsystem. In one embodiment of the present invention, the MDT 700 enables the underlying network device driver to amortize the input/output memory management unit (IOMMU) related overhead across a number of data packets transmitted in the kernel.

By reducing the overhead cost, the device driver needs to only perform the necessary IOMMU operations on two contiguous memory blocks representing the header information associated with the transmitted block of data comprising multiple packets of data. In one embodiment of the present invention, the MDT 700 with the assistance of the kernel's networking stack performs only the necessary IOMMU operations on the two contiguous memory blocks representing the header buffer and the data payload buffer during each transmit call to the transport module 720.

The MDT 700 achieves this by instructing the data generation module 710 to copy larger chunks of the application data into the kernel's buffer. In one embodiment of the present invention, the MDT 700 avoids having dependencies on the underlying network hardware or firmware. The MDT 700 further avoids changing the data generation framework of the data generation module 710 to minimize the potential impact on the stability and performance of the underlying operating system. The MDT 700 advantageously provides a mechanism to increase network application throughput and achieve a better utilization of the host computer's CPU without having to modify the underlying operating system.

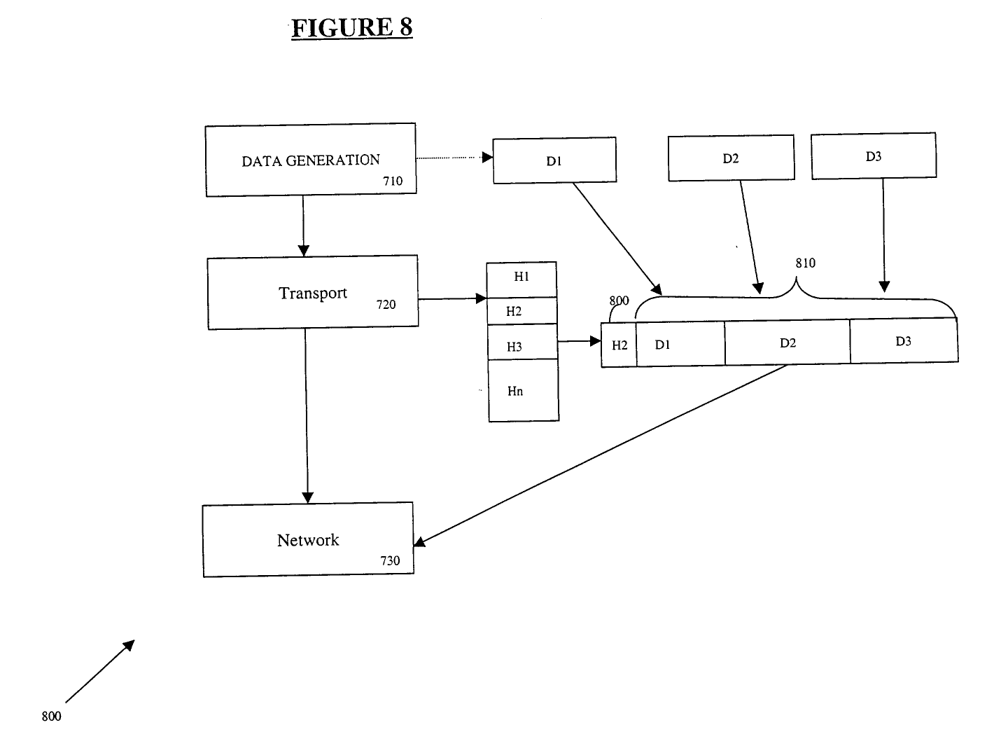

FIG. 8 is a block diagram illustration of one embodiment of the header generation logic of the MDT 700 of the present invention. As shown in FIG. 8, the data generation module 710 generates data chunks D1-D3 in response to a multi-data transmit request from the transport module 720. The transport module 720 creates a buffer table of headers with each header corresponding to one of a number of packets in the multi-data (payload) block presented by the data generation module 710.

The header buffer (H2) 800 is then linked to payload buffer 810 and transmitted to the network module 730. Buffering the data packet headers in a single header buffer, rather than multiple header buffers each time a data block is transmitted by the transport module 720, reduces the number of per-packet processing that the transport module 720 has to perform and reduces the overall overhead cost of processing the data. This reduces the per-packet processing cost in the modules underlying the transport module 720 by placing the header information 800 and payload information 810 (data) into two contiguous chunks of memory.

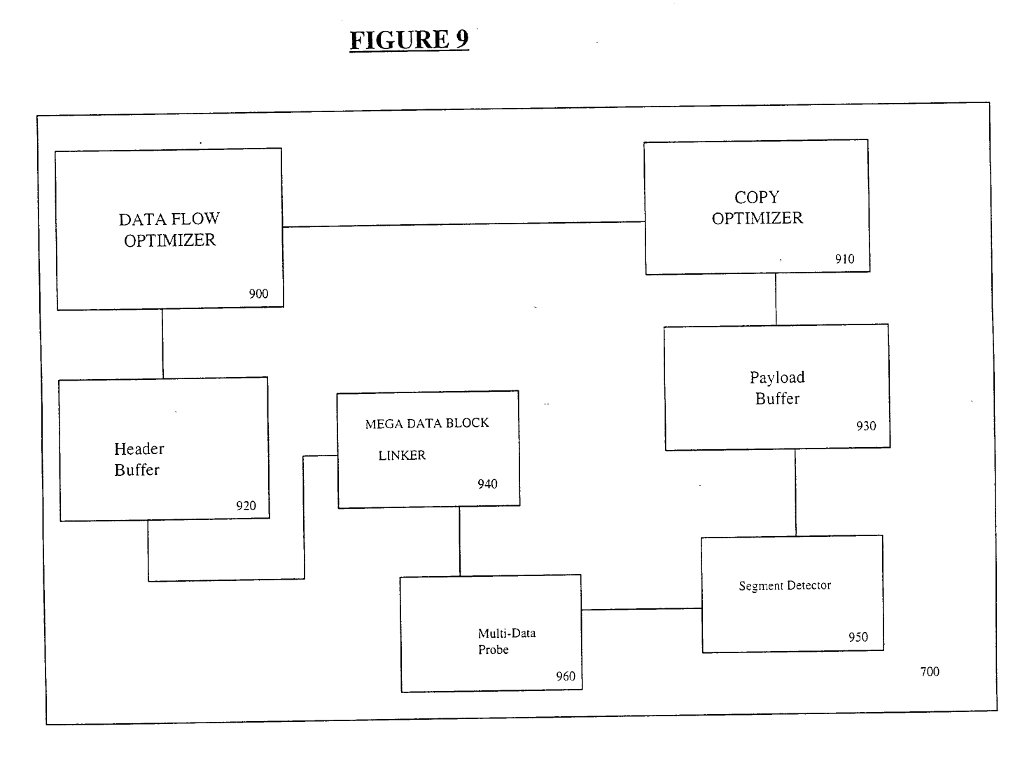

FIG. 9 is a block diagram illustration of one embodiment of the multi-data transmitter 700 of the present invention. The MDT 700 comprises a data flow optimizer 900, data copy logic 910, header buffer creation logic 920, payload buffer creation logic 930, buffer linking logic 940, segments detection logic 950 and a multi-data probe 960.

During a data transmission interface between the transport layer and the network layer, the multi-data probe 960 probes the data-link layer driver for its link parameters and capabilities. The multi-data probe 960 determines whether the device driver 740 supports multi-data transmission. If the device driver 740 of FIG. 7 supports multi-data transmission, the network module 730 notifies the transport module 720 to instruct the data generation module 710 to copy large blocks of the application data for transmission.

The data flow optimizer 900 provides a mechanism for allowing the transfer of bulk data between the data generation module 710 and the transport module 720. The data flow optimizer 700 handles the numerous context switches, allocation overhead, etc., that are prevalent in the transport of bulk data between the network sub-system modules to reduce per-modular block and inter module transport cost.

In one embodiment of the present invention, the data flow optimizer 700 reduces the inter-module transport cost of transmitting data from the upper layers of the network sub-system to the lower layers of the network sub-system. The cost in reducing the transfer of data results in the optimal flow of data through the network sub-system. In another embodiment of the present invention, the data flow optimizer 700 dynamically sub-divides data presented to the network subsystem into blocks based on the data transfer parameters of the underlying kernel application program, rather than using the pre-determined packet size transfers of the prior art.

The MDT 700 transmits multi-packets of data in a single transmission call and the transport module 720 takes advantage of this because data now resides in larger contiguous memory blocks rather than smaller blocks of the prior art. And depending on the send window of the network stack, many segments in these contiguous memory are transmitted in one call.

The header buffer generation logic 920 generates a table of header information corresponding to the data segments in the multi-segment data block. The contents of the header buffer are created based on the segment information provided by the segment detection logic 950 which provides the MDT 700 with the number of segments the transport module 720 can send.

Since the transport module 720 has knowledge of the number of segments it can send, the transport module 720 allocates a separate kernel buffer large enough to hold the meta header information of the segments generated by the payload buffer 930 along with their actual transport/network (TCP/IP) headers. This transport/network includes the total number of packets, along with the number of elements in the header and payload blocks, the location and length of each packet across the header and/or payload blocks and per-packet private information, such as those related to hardware checksum offloading.

The header information and the multi-segment payload information are linked by the buffer link logic 940 and sent down for transmission to the network module 730 and the device driver 740. In one embodiment of the present invention, the network module 730 utilizes the legacy transmission path for the data generated by the data generation module 710 if the MDT 700 determines that a particular data presented for transmission is not set for multi-data transmission.

When the device driver 740 receives the two blocks of data transmitted by the MDT 700 (header and payload blocks), it performs two IOMMU related operations (DVMA mappings and flushing); one is for the transport/network header portion, e.g., H2 in FIG. 8 and the other for the entire payload block, e.g., DB in FIG. 8. The device driver 740 then uses the information in the header buffer to lace each packet in the payload buffer into descriptor rings in the network module 730 before finally instructing the underlying hardware to perform a direct memory access transfer.

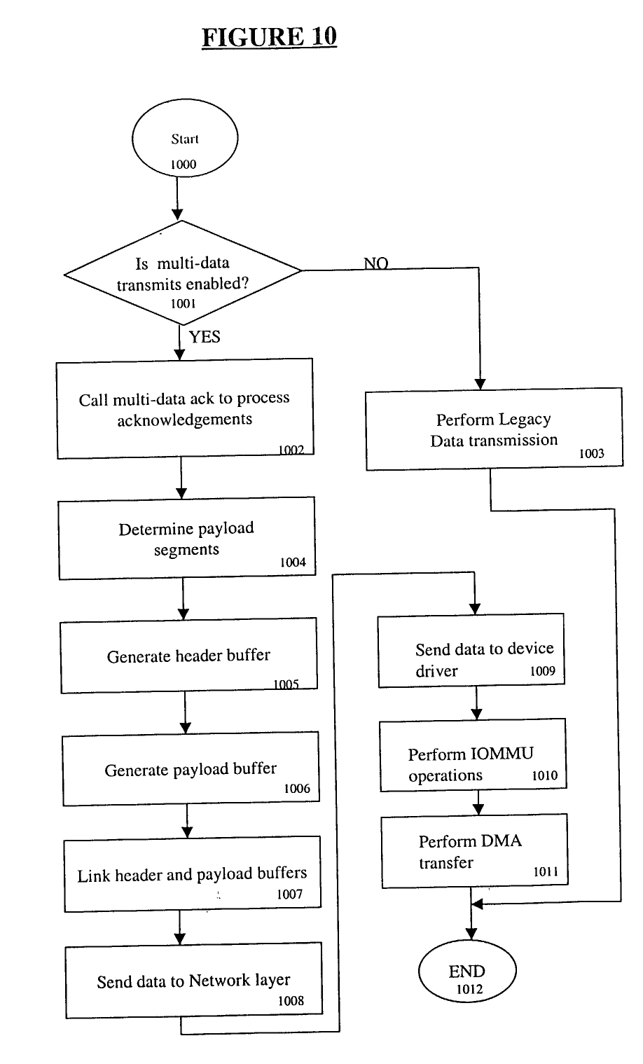

FIG. 10 is a computer controlled flow diagram of one embodiment of the multi-data transmission 1000 of the present invention. As shown in FIG. 10, an implementation of the multi-data transmission is initiated following a multi-data probe at step 1001 to the device driver 740 to determine whether the driver 740 supports multi-data transmission or has the capabilities for multi-data transmission. If the device driver 740 support multi-data transmission, the MDT 700 is enabled and an acknowledgement logic is set at step 1002 to enable multi-data processing. If, on the other hand, the underlying device driver 740 does not support multi-data processing, the system enables transmission of the application data in legacy mode at step 1003.

At step 1004, the MDT 700 determines the number of segments (packets) in the particular block of data being transmitted. The MDT 700 generates a header buffer at step 1005 after determining the number of packets to be transmitted with the transfer block of data.

At step 1006, the MDT 700 generates a payload buffer corresponding block of transferable data consisting of the segments of data to be transmitted. After generating the payload buffer, the MDT 700 links the header and payload buffers at step 1007 and sends the combined buffers to the network module 730 at step 1008. In the network module 730, the network module 730 calculates and fills the checksum information of each packet in the data block, if necessary. The header and payload block is then sent to the device driver 740 at step 1009.

At step 1010, the device driver 740 calculates the number of elements in both the header and payload block, obtains the header handle for the data block and instructs the hardware to perform a direct memory access transfer at step 1011 and completes the data transmission in a single call.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A computer system, comprising:
a processor;
a memory storage unit;
a device driver
an operating system comprising a kernel, said kernel comprising a network sub-system and a multi-data transmission system for allowing the transmission of a multi-packet application data block in a single transmission cycle in said network subsystem.

2. The computer system of claim 1, wherein said multi-packet application data block is a single block and comprises a contiguous block of a plurality of header information with a corresponding contiguous block of a plurality of data packets.

3. The computer system of claim 2, wherein said multi-data transmission system comprises multi-data copy logic for copying said multi-packet application data block between transmission modules in said network subsystem.

4. The computer system of claim 3, wherein said multi-data transmission system further comprises header buffer generation logic for generating said contiguous block of a plurality of header buffer information.

5. The computer system of claim 4, wherein said multi-data transmission system further comprises a payload buffer for generating said contiguous block of a plurality of data packets.

6. The computer system of claim 5, wherein said multi-data transmission system further comprises data linking logic for linking said contiguous block of a plurality of header information with said contiguous block of a plurality of data packets.

7. The computer system of claim 6, wherein said multi-data transmission system further comprises multi-data probe logic for determining whether said device driver handles multi-data processing.

8. The computer system of claim 7, wherein said multi-data transmission system further comprises segment detection logic for determining the number of packets in said contiguous block of a plurality of data packets to allocate in a buffer of said kernel.

9. The computer system of claim 1, wherein said device driver processes said multi-packet application data block in two input/output memory management operations to transfer said multi-packet application data block to said memory.

10. The computer system of claim 9, wherein said input/output memory management operations comprise a direct virtual memory access mapping operation and a flushing operation.

11. An operating system kernel, comprising:
a network subsystem;
a transport module for processing a multi-packet data block in a single transport cycle;
a network module for processing said multi-packet data block in a single network call; and
a multi-data transmission module for transmitting said multi-packet data block as a single data transmission block.

12. The operating system kernel of claim 11, wherein said data transmission block comprises a contiguous block of a plurality of header information with a corresponding contiguous block of a plurality of data packets embodied in a single data transmit block.

13. The operating system kernel of claim 12, wherein said network subsystem comprises transmission modules and wherein said multi-data transmission module comprises multi-data copy logic for copying said multi-packet data block between said transmission modules.

14. The operating system kernel of claim 13, wherein said multi-data transmission module further comprises header buffer generation logic for generating said contiguous block of a plurality of header buffer information.

15. The operating system kernel of claim 14, wherein said multi-data transmission module further comprises a payload buffer for generating said contiguous block of a plurality of data packets.

16. The operating system kernel of claim 15, wherein said multi-data transmission module further comprises data linking logic for linking said contiguous block of a plurality of header information with said contiguous block of plurality of data packets.

17. The operating system kernel of claim 16, further comprising a device driver and wherein said multi-data transmission module further comprises multi-data probe logic for determining whether said device driver handles multi-data processing.

18. The operating system kernel of claim 17, wherein said multi-data transmission module further comprises segment detection logic for determining the number of packets in said contiguous block of a plurality of data packets to allocate in a buffer of said kernel.

19. The operating system kernel of claim 11, wherein said multi-data transmission module processes said multi-packet application data block in two input/output memory management operations to transfer said multi-packet applications data block to system memory.

20. The operating system kernel of claim 19, wherein said input/output memory management operations comprises a direct virtual memory access mapping operation and a flushing operation.

21. In a computer implemented multi-data kernel transmission system comprising:
data generation logic for processing a kernel subsystem data generated to network devices coupled to said computer; and
a multi-data transmitter comprising a plurality of header buffers for dynamically generating a header information block of data processed by said data generation logic for transmission through data processing modules in said kernel subsystem;
wherein each of a plurality of header information is generated according to data transfer parameters set by an application program for said network devices.

22. A system as described in claim 21 wherein said multi-data transmitter further comprises a data buffer for storing a plurality of packets of data transmitted in a single transmission cycle to said network devices.

23. A system as described in claim 22 wherein said data is a kernel data structure of a computer operating system.

24. A system as described in claim 23 wherein said application program is aware of said data buffer for said data structure.

25. A method of transmitting a multi-packet data block from a computer operating kernel to a network device driver, comprising:
probing whether said device driver is programmed for a multi-data transmission;
determining whether said device driver is capable of processing a multi-packet data block;
generating a stream of data packets in a single transmission request;
generating said multi-packet data block; and
transmitting said multi-packet data block to said device driver.

26. The method of claim 25, wherein said generating said multi-packet data block comprises generating a header buffer of header information defining a first contiguous memory block representing packets of data to be transmitted.

27. The method of claim 26, wherein said generating said multi-packet data block further comprises generating a data buffer defining a second contiguous memory block for storing a plurality of data packets in said multi-packet data block.

28. The method of claim 27, wherein said generating said multi-packet data block further comprises linking said header buffer and said data buffer to define said multi-packet data block.
